(19) United States
(12) Patent Application Publication
(10) Pub. No.: US 2023/0075600 A1
(43) Pub. Date: Mar. 9, 2023

(54) NEURAL NETWORK PREDICTION USING TRAJECTORY MODELING

(71) Applicant: Microsoft Technology Licensing, LLC, Redmond, WA (US)

(72) Inventors: Yiming Ma, Menlo Park, CA (US); Lili Zhang, Redwood Ctiy, CA (US); Wei Kang, Los Altos, CA (US); Jaewon Yang, Sunnyvale, CA (US)

(21) Appl. No.: 17/468,028

(22) Filed: Sep. 7, 2021

(51) Int. Cl. G06N 3/08; G06N 3/04

(52) U.S. Cl. CPC G06N 3/088; G06N 3/0454; G06N 3/0445

(57) ABSTRACT

Techniques for training and using a neural network to make predictions using trajectory modelling are disclosed herein. In some embodiments, a computer-implemented method comprises: training a first neural network with a first machine learning algorithm using training data, the first neural network being a recurrent neural network, the training data including a plurality of reference career trajectories, each reference career trajectory in the plurality of reference career trajectories comprising a sequence of reference career segments, each reference career segment in the sequence of reference career segments comprising reference profile data and reference time data indicating a position of the reference career segment within the sequence of reference career segments, the training data also including a corresponding set of reference skills for each reference career segment.

### TECHNICAL FIELD

The present application relates generally to training and using a neural network to make predictions using trajectory modeling.

### BACKGROUND

Online service providers, such as social networking services, e-commerce and marketplace services, photo sharing services, job hosting services, educational and learning services, and many others, typically require that each end-user register with the individual service to establish a user account. In most instances, a user account will include or be associated with a user profile—a digital representation of a person's identity. As such, a user profile may include a wide variety of information about the user, which may vary significantly depending upon the particular type and nature of the online service. By way of example, in the context of a social networking service, a user's profile may include information such as: first and last name, e-mail address, age, location of residence, a summary of the user's educational background, job history, and/or experiences, as well as individual skills possessed by the user. A user profile may include a combination of structured and unstructured data. For example, whereas a user's age may be stored in a specific data field as structured data, other profile information may be inferred from a free form text field such as a summary of a user's experiences. Furthermore, while some portions of a user profile, such as an e-mail address, may be mandatory—that is, the online service may require the user to provide such information in order to register and establish an account—other portions of a user profile may be optional.

In many instances, the quality of the experience a user has with a particular online service may vary significantly based on the extent to which the user has provided information to complete his or her user profile. Generally, the more complete a user profile is, the more satisfied the user is likely to be with various features and functions of the online service. By way of example, consider the extent to which a user has listed in his or her profile for a professional social networking service the skills possessed by the user. In the context of a professional social networking service, a variety of content-related and recommendation services utilize various aspects of a user's profile information—particularly skills—for targeting users to receive various content and for generating recommendations. For example, a content selection and ranking algorithm associated with a news feed, which may be referred to as a content feed, or simply a feed, may select and/or rank content items for presentation in the user's personalized content feed based on the extent to which the subject matter of a content item matches the perceived interests of the user. Here, the user's perceived interests may be based at least in part on the skills that he or she has listed in his or her profile. Therefore, having an accurate and complete user profile will improve the quality of the content that the user receives in his or her personalized content feed. Similarly, a job-related search engine and/or recommendation service may select and/or rank job postings for presentation to a user based in part on skills listed in a profile of the user. Finally, a recommendation service for online courses may generate course recommendations for a user based at least in part on the skills that the user lists in his or her profile. Accordingly, the value of these services to the user can be significantly greater when the user has completed his or her profile by adding his or her skills. Specifically, with a completed profile and accurate list of skills, the user is more likely to receive relevant information that is of interest to the user.

However, when certain profile information is made optional, there are a variety of reasons that a user may be hesitant to add such information to his or her end-user profile. First, a user may not appreciate the increased value that he or she will realize from the various online services when his or her profile is complete. Second, a user may not understand how to add certain information to his or her profile, or a user may simply not want to take the time to add the information to his or her user profile. Finally, it may be difficult for a user to understand specifically what information—for example, which skills—the end-user should add to his or her user profile. Accordingly, many online services prompt users to add information to their user profile. For example, in the context of a social networking service—particularly a professional social networking service—a profile completion service may prompt users to add skills to their respective user profiles.

Some online services may suggest skills to be added to a user's profile. However, for a variety of reasons, current solutions for identifying skills for users fail to satisfy important technical requirements to meet the needs of online services having millions of users. For those few online services that may recommend or suggest specific skills be added to a user's profile, such skill suggestion services tend to be heuristic-based, and therefore lack scalability and personalization.

Heuristic or rule-based recommendation services do not scale well, in large part because of the extremely large number of possible users (e.g., millions), the significant variance in the characteristics of the users, and the nature of the skills being recommended. For example, users may be in different stages of their respective careers, such that some users are still students pursuing an educational degree, while other users may have a significant number of years of experience working within a specific industry. Moreover, users tend to have different experience levels when it comes to interacting and engaging with the online service. For instance, some users may be casual users of the online service, logging into and engaging with the online service only a few times per year, whereas other users may be daily users.

Furthermore, the skills being recommended differ significantly. For instance, some skills may be considered “soft” skills, where the bar for determining possession of the skill is quite low, whereas other skills may be considered “hard” skills, such that the bar for determining possession of the skill is quite high. Some skills may be popular or common, such that large groups of users are likely to possess these skills, while others are rare, possessed by only a small percentage of users.

Moreover, as technology and labor requirements change over time, new skills arise, and formerly common skills tend to fade or decrease in popularity. Accordingly, the decision-making process that a person must go through to determine whether he or she possesses a skill will vary significantly from one skill to the next. Consequently, encoding this decision-making process in a set of rules for a heuristic-based skill ranking and recommendation system becomes extremely complex, and does not scale well. Because of all of the variance in characteristics of both users and skills, from a technical perspective, it is extremely difficult to implement an efficient, scalable, and effective heuristic-based service for identifying skills for users.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating functional components of an online service, in accordance with an example embodiment.

FIG. 2 is a block diagram showing the functional components of a neural network, in accordance with an example embodiment.

FIG. 3 is a block diagram showing the functional components of another neural network, in accordance with an example embodiment.

FIG. 4 is a block diagram illustrating the functional components of a recurrent neural network, in accordance with an example embodiment.

FIG. 5 illustrates a graphical user interface (GUI) in which a user may add one or more skills to a profile of the user, in accordance with an example embodiment.

FIG. 6 illustrates a GUI in which job postings are displayed, in accordance with an example embodiment.

FIG. 7 is a flowchart illustrating a method of training and using a neural network to make predictions using trajectory modelling, in accordance with an example embodiment.

FIG. 8 is a flowchart illustrating another method of training and using a neural network to make predictions using trajectory modelling, in accordance with an example embodiment.

FIG. 9 is a block diagram illustrating a software architecture, in accordance with an example embodiment.

FIG. 10 illustrates a diagrammatic representation of a machine in the form of a computer system within which a set of instructions may be executed for causing the machine to perform any one or more of the methodologies discussed herein, in accordance with an example embodiment.

### DETAILED DESCRIPTION

I. Overview

Example methods and systems of implementing neural network prediction using trajectory modelling are disclosed. In the following description, for purposes of explanation, numerous specific details are set forth in order to provide a thorough understanding of example embodiments. It will be evident, however, to one skilled in the art that the present embodiments may be practiced without these specific details.

The above-discussed technical problems of efficiency, scalability, and effectiveness are addressed by one or more example embodiments disclosed herein, in which a specially-configured computer system is configured to train a first neural network using a plurality of reference career trajectories, where each reference career trajectory in the plurality of reference career trajectories comprises a sequence of reference career segments. Each reference career segment in the sequence of reference career segments comprises reference profile data, as well as reference time data indicating a position of the reference career segment within the sequence of reference career segments. The training data also includes a corresponding set of reference skills for each reference career segment. The term “reference” is used herein to indicate data and entities being used or involved in the training of the first neural network. The trained first neural network may be used to compute a corresponding score for each target skill in a set of target skills by applying a target career trajectory of a target user to the trained first neural network model. The target career trajectory may comprise a sequence of target career segments, with each target career segment in the sequence of target career segments comprising target profile data of the target user and target time data indicating a position of the target career segment within the sequence of target career segments. The corresponding scores for the set of target skills may be used in an application of an online service, such as in selecting skills to recommend for the target user to add to the profile of the target user, in determining search results for a search query submitted by the target user, or in selecting job postings to recommend to the target user. The term “target” is used herein to indicate data and entities being used or involved in the use of the trained first neural network.

Training the first neural network model using the reference career trajectories, as disclosed herein, improves the effectiveness, efficiency, and scalability of the computer system that is being used to identify skills for users. By using the trained first neural network model instead of a heuristic-based approach, the computer system is able to accommodate the significant variance in the characteristics of the users in a more scalable way. The computer system is also able to adapt to real-world changes more quickly than the heuristic-based approach. The extremely complex encoding of the heuristic-based decision-making process is avoided, and the variance in characteristics of both users and skills is more effectively processed, resulting in a faster and more accurate computer system. Other technical effects will be apparent from this disclosure as well.

II. Detailed Example Embodiments

The methods or embodiments disclosed herein may be implemented as a computer system having one or more components implemented in hardware or software. For example, the methods or embodiments disclosed herein may be embodied as instructions stored on a machine-readable medium that, when executed by one or more hardware processors, cause the one or more hardware processors to perform the instructions.

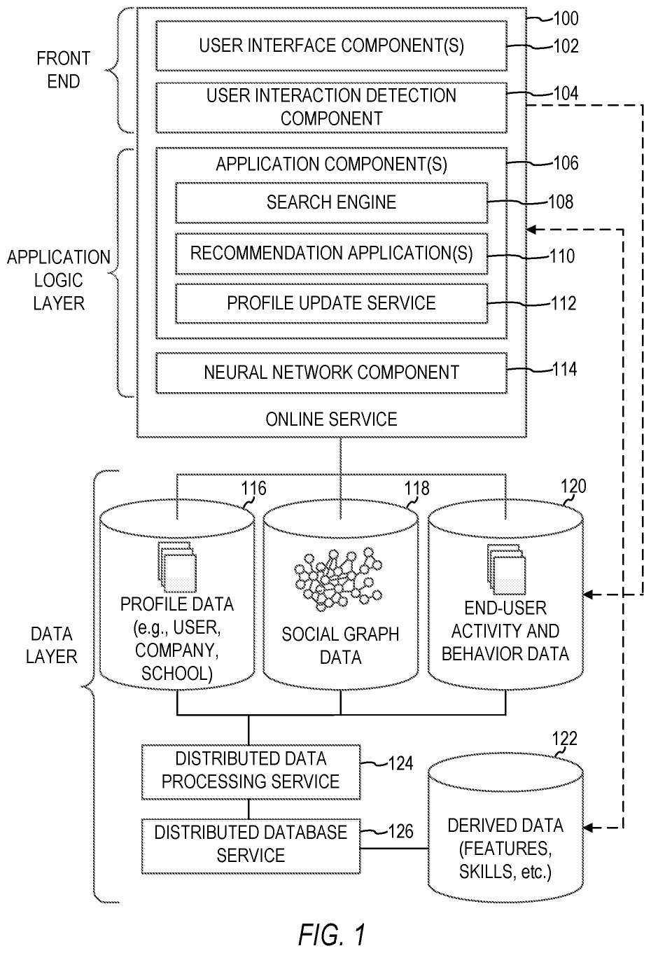

FIG. 1 is a block diagram illustrating functional components of an online service 100, in accordance with an example embodiment. As shown in FIG. 1, a front end may comprise one or more user interface components (e.g., a web server) 102, which receives requests from various client computing devices and communicates appropriate responses to the requesting client devices. For example, the user interface component(s) 102 may receive requests in the form of Hypertext Transfer Protocol (HTTP) requests or other web-based API requests. In addition, a user interaction detection component 104, sometimes referred to as a click tracking service, may be provided to detect various interactions that end-users have with different applications and services, such as those included in the application logic layer of the online service 100. As shown in FIG. 1, upon detecting a particular interaction, the user interaction detection component 104 logs the interaction, including the type of interaction and any metadata relating to the interaction, in an end-user activity and behavior database 120. Accordingly, data from this database 120 can be further processed to generate data appropriate for training one or more machine-learned models, and in particular, for training models to rank a set of skills for an end-user.

An application logic layer may include one or more application server components 106, which, in conjunction with the user interface component(s) 102, generate various user interfaces (e.g., web pages) with data retrieved from various data sources in a data layer. Consistent with some embodiments, individual application server components 106 implement the functionality associated with various applications and/or services provided by the online service 100. For instance, as illustrated in FIG. 1, the application logic layer includes a variety of applications and services to include a search engine 108, one or more recommendation applications 110 (e.g., a job recommendation application, an online course recommendation application), and a profile update service 112. The various applications and services illustrated as part of the application logic layer are provided as examples and are not meant to be an exhaustive listing of all applications and services that may be integrated with and provided as part of the online service 100. For example, although not shown in FIG. 1, the online service 100 may also include a job hosting service via which end-users submit job postings that can be searched by end-users, and/or recommended to other end-users by the recommendation application(s) 110. As end-user's interact with the various user interfaces and content items presented by these applications and services, the user interaction detection component 104 detects and tracks the end-user interactions, logging relevant information for subsequent use.

As shown in FIG. 1, the data layer may include several databases, such as a profile database 116 for storing profile data, including both end-user profile data and profile data for various organizations (e.g., companies, schools, etc.). Consistent with some embodiments, when a person initially registers to become an end-user of the online service, the person will be prompted by the profile update service 114 to provide some personal information, such as his or her name, age (e.g., birthdate), gender, interests, contact information, home town, address, spouse's and/or family members' names, educational background (e.g., schools, majors, matriculation and/or graduation dates, etc.), employment history, skills, professional organizations, and so on. This information is stored, for example, in the profile database 116. Similarly, when a representative of an organization initially registers the organization with the online service 100, the representative may be prompted to provide certain information about the organization. This information may be stored, for example, in the profile database 116, or another database (not shown).

Once registered, an end-user may invite other end-users, or be invited by other end-users, to connect via the online service 100. A “connection” may constitute a bilateral agreement by the end-users, such that both end-users acknowledge the establishment of the connection. Similarly, with some embodiments, an end-user may elect to “follow” another end-user. In contrast to establishing a connection, the concept of “following” another end-user typically is a unilateral operation and, at least with some embodiments, does not require acknowledgement or approval by the end-user that is being followed. When one end-user follows another, the end-user may receive status updates relating to the other end-user, or other content items published or shared by the other end-user user who is being followed. Similarly, when an end-user follows an organization, the end-user becomes eligible to receive status updates relating to the organization as well as content items published by, or on behalf of, the organization. For instance, content items published on behalf of an organization that an end-user is following will appear in the end-user's personalized feed, sometimes referred to as a content feed or news feed. In any case, the various associations and relationships that the end-users establish with other end-users, or with other entities (e.g., companies, schools, organization) and objects (e.g., metadata hashtags (“#topic”) used to tag content items), are stored and maintained within a social graph in a social graph database 118.

As end-users interact with the various content items that are presented via the applications and services of the online service 100, the end-users' interactions and behaviors (e.g., content viewed, links or buttons selected, messages responded to, job postings viewed, etc.) are tracked by the user interaction detection component 104, and information concerning the end-users' activities and behaviors may be logged or stored, for example, as indicated in FIG. 1 by the end-user activity and behavior database 120.

Consistent with some embodiments, data stored in the various databases of the data layer may be accessed by one or more software agents or applications executing as part of a distributed data processing service 124, which may process the data to generate derived data. The distributed data processing service 124 may be implemented using Apache Hadoop® or some other software framework for the processing of extremely large data sets. Accordingly, an end-user's profile data and any other data from the data layer may be processed (e.g., in the background or offline) by the distributed data processing service 124 to generate various derived profile data. As an example, if an end-user has provided information about various job titles that the end-user has held with the same organization or different organizations, and for how long, this profile information can be used to infer or derive an end-user profile attribute indicating the end-user's overall seniority level or seniority level within a particular organization. This derived data may be stored as part of the end-user's profile or may be written to another database.

In addition to generating derived attributes for end-users' profiles, one or more software agents or applications executing as part of the distributed data processing service 124 may ingest and process data from the data layer for the purpose of generating training data for use in training various machine-learned models, and for use in generating features for use as input to the trained models. For instance, profile data, social graph data, and end-user activity and behavior data, as stored in the databases of the data layer, may be ingested by the distributed data processing service 124 and processed to generate data properly formatted for use as training data for training one of the aforementioned machine-learned models for ranking skills. Similarly, the data may be processed for the purpose of generating features for use as input to the machine-learned models when ranking skills for a particular end-user. Once the derived data and features are generated, they are stored in a database 122, where such data can easily be accessed via calls to a distributed database service 124.

In some example embodiments, the application logic layer of the online service 100 also comprises a neural network component 114 that is configured to train and use one or more neural networks to compute scores for skills, and then use the computed scores in one or more application server components 106 of the online service 100. For example, the computed scores may be used by the search engine 108, the recommendation application(s) 110, or the profile update service 112. The neural network component 114 may train the neural network(s) to compute the scores based on career trajectory information.

In some example embodiments, a career trajectory (ct) is a list of career segments (cs₁, . . . , csₖ) that form a path for a user, such as a career path, where ct=[cs₁, . . . , csₖ]. The list of career segments may comprise a sequence of career segments that are sorted by time data of the career segments, where the time data indicates a position of the career segment within the sequence of career segments. The time data may comprise a start time (e.g., a month and year) at which the career segment began and an end time (e.g., a month and year) at which the career segment ended.

Each career segment may also comprise one or more profile data from a group of profile data consisting of a job title (e.g., software engineer), a seniority level (e.g., junior), a company (e.g., Acme Inc.), an industry (e.g., computer software), a description of the corresponding reference career segment (e.g., a text description of work performed in the career segment). For example, a career segment may be represented as follows:
cs={title, seniority, company, industry, text description, start, end}.
   Other types and configurations of profile data may be used for each career segment. The neural network component 114 may retrieve the profile data for each career segment from the database 116 or from the database 122.

Each career segment of a user may have a corresponding set of skills associated with it. In some example embodiments, the neural network component 114 may determine the corresponding set of skills for each career segment of the user. For example, the neural network component 114 may retrieve the set of skills from the database 116 or from the database 122, including, but not limited to, skills that the user has input into the profile of the user. The neural network component 114 may also analyze the end-user activity and behavior data in the database 120 to determine one or more skills of the user, such as by determining skills that are associated with content with which the user has interacted with during the time period of the career segment. For example, if the user applied to job postings for which a skill was included in the applied-for job postings, then the neural network component 114 may use that skill in the set of skills for the career segment that corresponds to the time period during which the user applied for the job postings. In some example embodiments, the neural network component 114 may use a threshold number of occurrences to determine whether to include such a skill in the set of skills for the career segment. For example, the neural network component 114 may use a threshold number of three and determine that skill A is to be included in the set of skills for a career segment because the user applied for four job postings that included skill A as a requirement, but may determine that skill B is not to be included in the set of skills for the career segment because the user applied for only one job posting that included skill B as a requirement.

In some example embodiments, the neural network component 114 is configured to generate the training data to be input into a machine learning algorithm for training a neural network. The neural network may be trained to solve the following algorithmic problem: given a skill set {sᵢ} and a career segment csⱼ in a career trajectory ct, compute a score (sᵢ|csⱼ), such that the score factors in the relationship or importance of a skill sᵢ in the career segment csⱼ. Each instance of training data may include the career segment csⱼ and the skill set Once the neural network is trained, the neural network component 114 may input a career segment of a user into the trained neural network to output scores for skills.

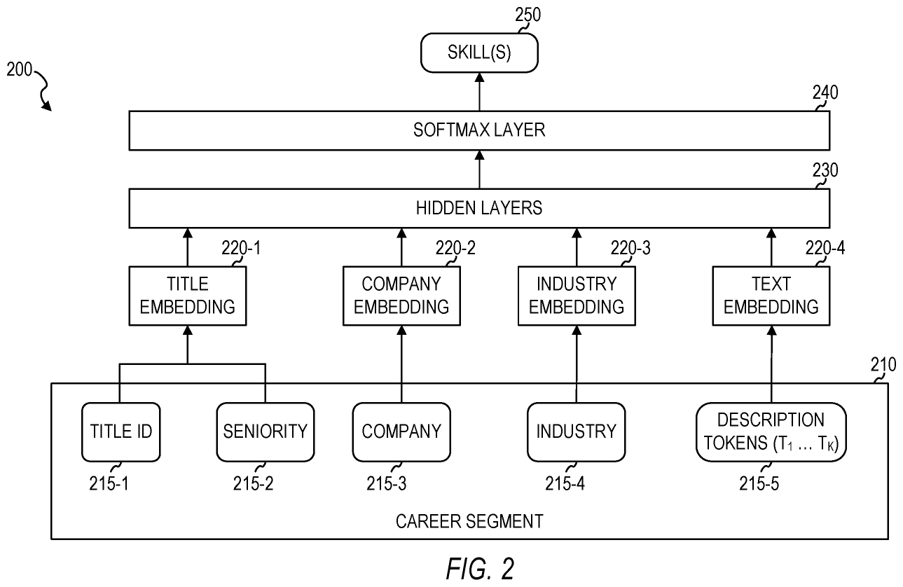

FIG. 2 is a block diagram showing the functional components of a neural network 200, in accordance with an example embodiment. In the example shown in FIG. 2, the neural network 200 has been trained to output a probability distribution of skills 250 based on an input career segment 210 comprising input profile data 215. The probability distribution of skills 250 are computed by the neural network 200 as the scores for the skills and may comprise corresponding probabilities for the skills. The input profile data 215 may comprise one or more input profile data 215 from a group of profile data consisting of a job title 215-1, a seniority level 215-2, a company 215-3, an industry 215-4, and a description of the career segment 215-5 (e.g., in the form of tokens Ti, TK representing text describing the career segment). The term “input” is used herein in association with “career segment” and “profile data” to indicate data being used or involved in the use of the trained neural network 200.

The neural network 200 may be configured to generate corresponding embedding vectors 220 for the input profile data 215, such as a title embedding vector 220-1 for the job title 215-1 and the seniority 215-2, a company embedding vector 220-2 for the company 215-3, an industry embedding vector 220-3 for the industry 215-4, and a text embedding vector 220-4 for the description of the career segment 215-5. In some example embodiments, the generation of the embedding vectors 220 may comprise a linear transformation of a column vector to a transformation matrix. The column vector may be sparse (e.g., more than 10K dimensions), and the transformation matrix may project the sparse dimensions into a dense vector of significantly reduced dimensionality (e.g., 128). The neural network 200 may also take in predefined embedding vectors 220 and start directly from the embedding vectors 220 as inputs.

In some example embodiments, the neural network 200 comprises hidden layers 230. The hidden layers 230 may comprise non-linear transformation layers that capture the relationship between the different components of the career segment 210 based on the input of the embedding vectors 220. The hidden layers 230 may output an embedding vector of the career segment that captures the relationship between the different components of the career segment 210. The neural network 200 may also comprise a softmax layer 240 that takes the embedding vector of the career segment from the hidden layers 230 and generates the probability of skills 250 based on the embedding vector of the career segment.

The neural network 200 is efficient to train compared to the complexity involved in building a heuristic-based solution, thereby improving scalability. However, the neural network 200 does not take into account a user's complete career trajectory, as each career segment is processed in isolation, independently from other career segments of the user's career trajectory, thereby not factoring in the dependency of one career segment on another career segment. Therefore, in some example embodiments, another neural network is trained and used to compute scores for skills using multiple career segments of a career trajectory of a user.

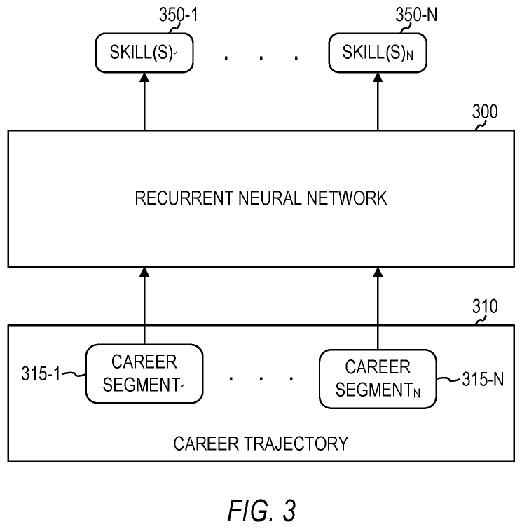

FIG. 3 is a block diagram showing the functional components of another neural network 300, in accordance with an example embodiment. In some example embodiments, the neural network component 114 trains the neural network 300 with a machine learning algorithm using training data that includes a plurality of reference career trajectories. Each reference career trajectory in the plurality of reference career trajectories comprises a sequence of reference career segments, with each reference career segment in the sequence of reference career segments comprising reference profile data and reference time data indicating a position of the reference career segment within the sequence of reference career segments. The training data also including a corresponding set of reference skills for each reference career segment.

Once the neural network 300 is trained, the neural network component 114 may obtain a target career trajectory 310 of a target user of the online service 100 and may compute a corresponding score for each target skill in a set of target skills by applying the target career trajectory 310 to the trained neural network 300. In some example embodiments, the target career trajectory 310 comprises a sequence of target career segments 315-1 to 315-N. Each target career segment 315 may comprise target profile data of the target user and target time data indicating a position of the target career segment 315 within the sequence of target career segments 315-1 to 315-N. In some example embodiments, the computing of the scores for the target skills includes generating a corresponding probability distribution of skills 350 for each target career segment 315. For example, the neural network 300 may generate a probability distribution of skills 350-1 for a target career segment 315-1, a probability distribution of skills 350-2 for a target career segment 315-2, a probability distribution of skills 350-3 for a target career segment 315-3, and so on and so forth for all of the target career segments 315 in the target career trajectory 310.

In some example embodiments, the neural network 300 comprises a recurrent neural network. A recurrent neural network is an artificial neural network where connections between nodes form a directed graph along a temporal sequence, thereby allowing the recurrent neural network to exhibit temporal dynamic behaviour. A recurrent neural network can use its internal state (e.g., memory) to process variable length sequences of inputs.

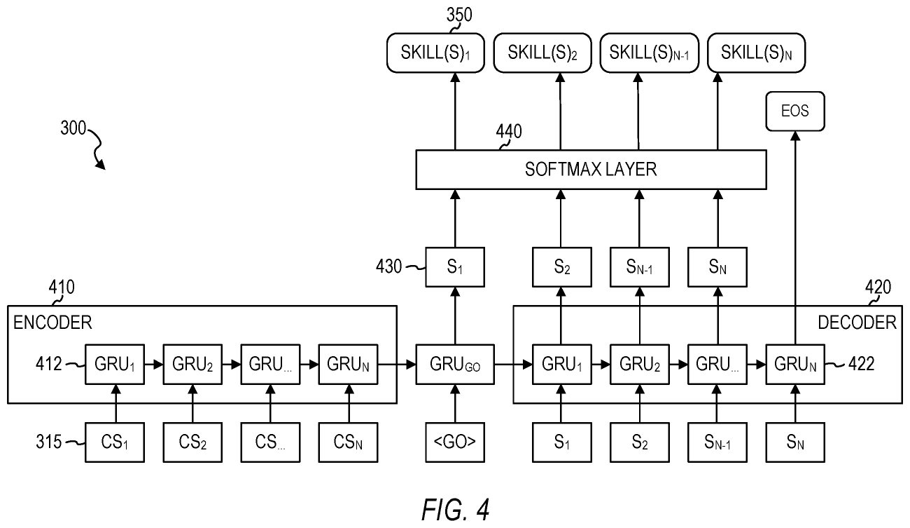

FIG. 4 is a block diagram illustrating the functional components of the neural network 300 implemented as a recurrent neural network, in accordance with an example embodiment. In some example embodiments, the neural network 300 comprises an encoder-decoder architecture that includes an encoder network 410 and a decoder network 420. The encoder network 410 may comprise a first plurality of gated recurrent units (GRU's) 412 and the decoder network 420 comprises a second plurality of gated recurrent units (GRU's) 422. Alternatively, a first plurality of long short-term memory units may be used in place of the GRU's 412 in the encoder network 410 and a second plurality of long short-term memory units may be used in place of the GRU's 422 in the decoder network 420.

In some example embodiments, the encoder network 410 is configured to use the GRU's 412 to encode the target career trajectory 310. Embedding vectors for the target career segments 315 of the target career trajectory 310 may be input into the encoder network 410. The encoder network 410 may then output a compressed vector representation of the target career segments 315 of the target career trajectory 310.

In some example embodiments, the decoder network 420 is configured to use the GRU's 422 to generate embedding vectors for skills 430, which may then be used by a softmax layer 440 to generate a corresponding probability distribution of skills 350 for each target career segment 315. In the encoder network 420, each embedding vector for skills 430 may be used as input for the next subsequent GRU 422 to determine the next embedding vector for skills 430. For example, the first embedding vector for skills S₁ may be used as input into GRU₁ to generate the second embedding vector for skills S₂, which may then be used as input into GRU₂ to generate the next embedding vector, and so on and so forth. The first embedding vector for skills S1 may be generated by inputting the compressed vector representation of the target career segments 315 of the target career trajectory 310 from the encoder network 410 into GRU_{Go} along with a meta token <GO>.

In certain situations, there may be insufficient training data to use for training the neural network 300. For example, although the online service 100 may have plenty of career trajectories 310, the online service 100 may lack sufficient associations of skills with the career segments 315 in the career trajectories 310, such as due to previously-discussed problems with users adding skills to their profiles. In order to address this technical problem of a lack of training data, the neural network component 114 may use the neural network 200 in FIG. 2 to generate the skills to use in the training data that is used to train the neural network 300 in FIG. 3. In some example embodiments, the neural network 200 is not a recurrent neural network, while the neural network 300 is a recurrent neural network. Here, the neural network component 114 leverages the speed and accuracy of the neural network 200 to generate the training data in an efficient and accurate way, and then uses the more complex and more accurate neural network 300 to generate scores.

The neural network 300 may select one or more skills from the last probability distribution of skills 350 (e.g., SKILL(S)_{N}) in FIG. 4) for use by the application server component(s) 106 for use in one or more applications of the online service 100. For example, the neural network 300 may select a top K number of skills (e.g., the top five skills) having the highest scores (e.g., highest probabilities) in the probability distribution of skills 350, and then feed the selected skills into the application server component(s) 106. Alternatively, the neural network 300 may select any skills in the probability distribution of skills 350 that have a score (e.g., probability) that is equal to or greater than a minimum threshold value, and then feed the selected skills into the application server component(s) 106. Instead of the neural network 300 selecting the skills itself, the neural network component 114 may feed the last probability distribution of skills 350 (e.g., SKILL(S)_{N}) in FIG. 4) into the application server component(s) 106, which may select one or more of the skills (e.g., using the top-K or minimum threshold value techniques previously discussed) for use in one or more applications of the online service 100.

In some example embodiments, the profile update service 112 uses the scores generated by the neural network component 114 (e.g. by the neural network 300) for a set of target skills of a target user to recommend one or more skills for the target user to add to the profile of the target user. For example, the profile update service 112 may select one or more target skills from the set of target skills included in the probability distribution of skills 350 generated by the neural network 300 based on the scores (e.g., the probabilities) of the target skills, such as by ranking the target skills based on their corresponding score and selecting the top-K highest ranked target skills, or by selecting all of the target skills having a score that is equal to or above a minimum threshold value. The profile update service 112 may then present the selected target skills as recommendations to the target user.

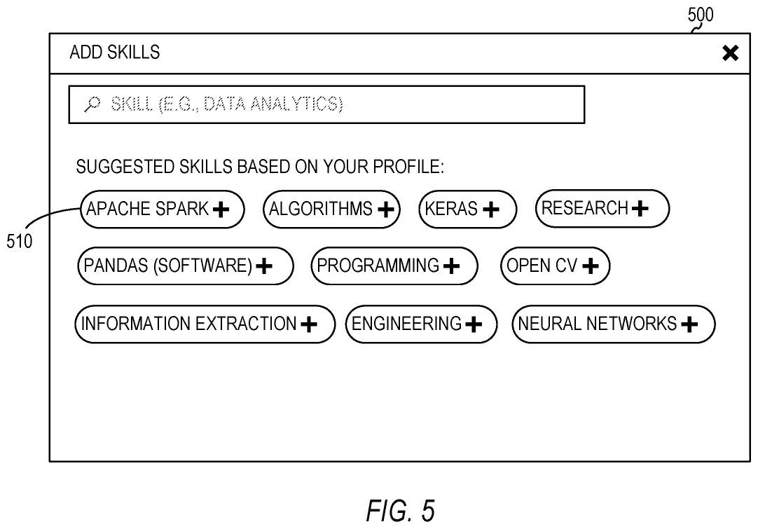

FIG. 5 illustrates a graphical user interface (GUI) 500 in which a user may add one or more skills to a profile of the user, in accordance with an example embodiment. In the example shown in FIG. 5, the profile update service 112 displays the GUI 500, including a corresponding selectable user interface element 510 for each one of the selected target skills. In some example embodiments, the selectable user interface element 510 is configured to trigger storing of the corresponding target skill as part of a profile of the target user in response to a selection of the corresponding selectable user interface element 510. For example, selection of the selectable user interface element 510 of one of the target skills may result in the target skill being stored in the database 116 in association with the profile of the target user.

In some example embodiments, the recommendation application 110 uses the scores generated by the neural network component 114 (e.g. by the neural network 300) for a set of target skills of a target user to recommend other content items for the target user. For example, the recommendation application 110 may comprise a job recommendation application that uses the score to determine which job postings to recommend to the target user. The recommendation application 110 may compute a corresponding score for each job posting in a plurality of job postings based on the corresponding scores for the set of target skills. For example, the recommendation application 110 may compute a corresponding score for each job posting based on a comparison of a set of skills that are associated with the job posting with the set of target skills of the target user, such that the more closely the skills associated with the job posting match the target skills of the target user, the higher the score for the job posting. The recommendation application 110 may weight each target skill based on its corresponding probability on the probability distribution. For example, a first target skill with a probability of 0.8 may have more of a positive effect on the score for a job posting than a second target skill with a probability of 0.2 even though both the first and second target skills match skills associated with the job posting. Other ways of computing scores for the job postings using the scores for the target skills of the target user are also within the scope of the present disclosure.

In some example embodiments, the recommendation application 110 selects one or more job postings from the plurality of job postings based on the corresponding scores for the job postings. For example, the recommendation application 110 may rank the job postings based on their scores and then select the top-K highest ranked job postings (e.g., the top ten highest ranked job postings). Alternatively, the recommendation application 110 may select all of the job postings having a score that is equal to or above a minimum threshold value. After selecting the job postings, the recommendation application 110 may displaying the selected job postings on a computing device of the target user.

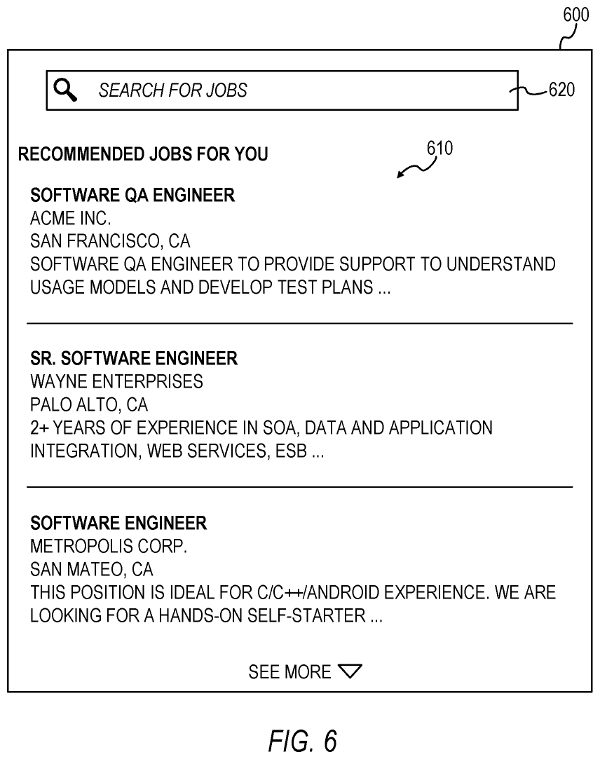

FIG. 6 illustrates a GUI 600 in which job postings 610 are displayed, in accordance with an example embodiment. The job postings 610 are displayed as recommendations to the target user on a computing device of the target user and may each comprise one or more corresponding selectable user interface elements (e.g., hyperlinked text) configured to display more information about the corresponding online job posting 610 (e.g., to view the entire online job posting rather than just an abbreviated summary of the online job posting) or to enable the user to perform some other type of online action directed towards the online job posting 610, such as saving the online job posting or applying to the online job posting. Each job posting 610 may include information about the corresponding online job posting. For example, the job posting 610 may include information including, but not limited to, a job title, a company name, a geographical location, and desired skills, educational background, and work experience. Other types of information may also be included in the job posting 610.

The GUI 600 may also display one or more user interface elements 620 configured to enable the user to submit a search query for searching for online job postings, such as by entering keyword search terms into a search field. In response to one or more keywords being submitted by the user as part of a search query via the search field, the search engine 108 may generate search results. In some example embodiments, the search engine 108 uses the corresponding scores for the skills of the target user to generate search results. For example, the search engine 108 may receive a search query submitted by the target user via a computing device of the target user, compute a corresponding score for each job posting in a plurality of job postings based on the search query and the corresponding scores for the set of skills, and then select one or more job postings from the plurality of job postings based on the corresponding scores for the one or more job postings. The selected job postings may then be displayed by the search engine 108 as search results for the search query on the computing device of the target user.

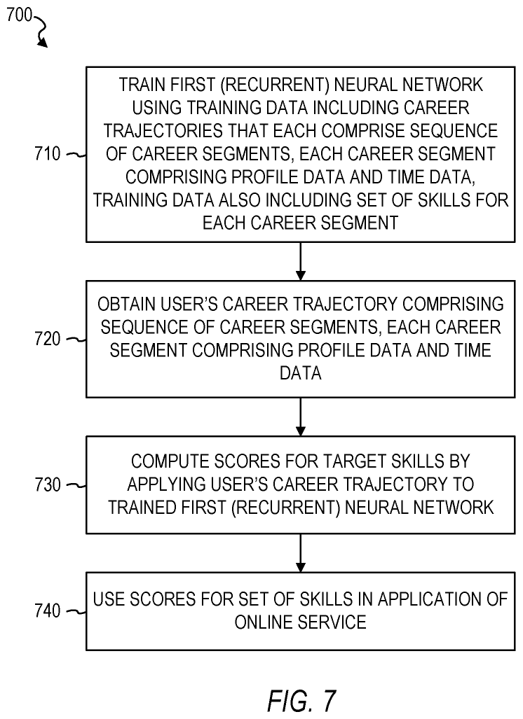

FIG. 7 is a flowchart illustrating a method 700 of training and using a neural network to make predictions using trajectory modelling, in accordance with an example embodiment. The method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the online service 100 of FIG. 1, or any combination of one or more of its components (e.g., the neural network component 114, the application component 106), as described above.

At operation 710, the online service 100 trains a first neural network with a first machine learning algorithm using training data. In some example embodiments, the first neural network is a recurrent neural network, such as the recurrent neural network 300 discussed above with respect to FIG. 3. The training data may include a plurality of reference career trajectories, with each reference career trajectory in the plurality of reference career trajectories comprising a sequence of reference career segments. Each reference career segment in the sequence of reference career segments may comprise reference profile data and reference time data indicating a position of the reference career segment within the sequence of reference career segments. The training data may also include a corresponding set of reference skills for each reference career segment.

In some example embodiments, the first neural network comprises an encoder-decoder architecture that includes an encoder network and a decoder network. The encoder network may comprise a first plurality of gated recurrent units and the decoder network may comprise a second plurality of gated recurrent units, such as shown in the example embodiment of FIG. 4. The encoder network and the decoder network may be comprised in other ways as well, including, but not limited to the encoder network comprising a first plurality of long short-term memory units and the decoder network comprising a second plurality of long short-term memory units.

In some example embodiments, the reference profile data comprises one or more profile data from a group of profile data consisting of: a job title, a seniority level, a company, an industry, a description of the corresponding reference career segment. Other types of reference profile data are also within the scope of the present disclosure.

At operation 720, the online service 100 obtains a target career trajectory of a target user of an online service. In some example embodiments, the target career trajectory comprises a sequence of target career segments, with each target career segment in the sequence of target career segments comprising target profile data of the target user and target time data indicating a position of the target career segment within the sequence of target career segments. The target profile data may comprise one or more profile data from a group of profile data consisting of: a job title, a seniority level, a company, an industry, a description of the corresponding target career segment. However, other types of target profile data are also within the scope of the present disclosure.

At operation 730, the online service 100, for each target skill in a set of target skills, computes a corresponding score for the respective target skill by applying the target career trajectory to the trained first neural network. For example, the online service 100 may feed the target career segments of the target career trajectory into the first neural network, resulting in an output including a probability of distribution for the target skills. The corresponding probability for each target skill may be the corresponding score for target skill.

At operation 740, the online service 100 uses the corresponding scores for the set of target skills in an application of the online service. In some example embodiments, the profile update service 112 of the online service 100 selects one or more target skills from the set of target skills based on the corresponding scores of the one or more target skills, and then displays a corresponding selectable user interface element for each one of the selected one or more target skills on a computing device of the target user, such as shown in FIG. 5. The selectable user interface element may be configured to trigger storing of the corresponding target skill as part of a profile of the target user in response to a selection of the selectable user interface element.

In another example embodiments, the search engine 108 of the online service 100 receives a search query submitted by the target user via a computing device of the target user, and computes a corresponding score for each job posting in a plurality of job postings based on the search query and the corresponding scores for the set of skills. The search engine 108 may then select one or more job postings from the plurality of job postings based on the corresponding scores for the one or more job postings, and display the selected one or more job postings as search results for the search query on the computing device of the target user.

In yet another embodiment, the recommendation application 110 computes a corresponding score for each job posting in a plurality of job postings based on the corresponding scores for the set of skills, and then selects one or more job postings from the plurality of job postings based on the corresponding scores for the one or more job postings. The recommendation application 110 may then display the selected one or more job postings on a computing device of the target user, such as shown in FIG. 6.

In yet another embodiment, the recommendation application 110 computes a corresponding score for each online course in a plurality of online courses based on the corresponding scores for the set of skills, and then selects one or more online courses from the plurality of online courses based on the corresponding scores for the one or more online courses. The recommendation application 110 may then display the selected one or more online courses on a computing device of the target user. The corresponding scores for the set of target skills may be used in other applications of the online service 100 as well.

It is contemplated that any of the other features described within the present disclosure can be incorporated into the method 700.

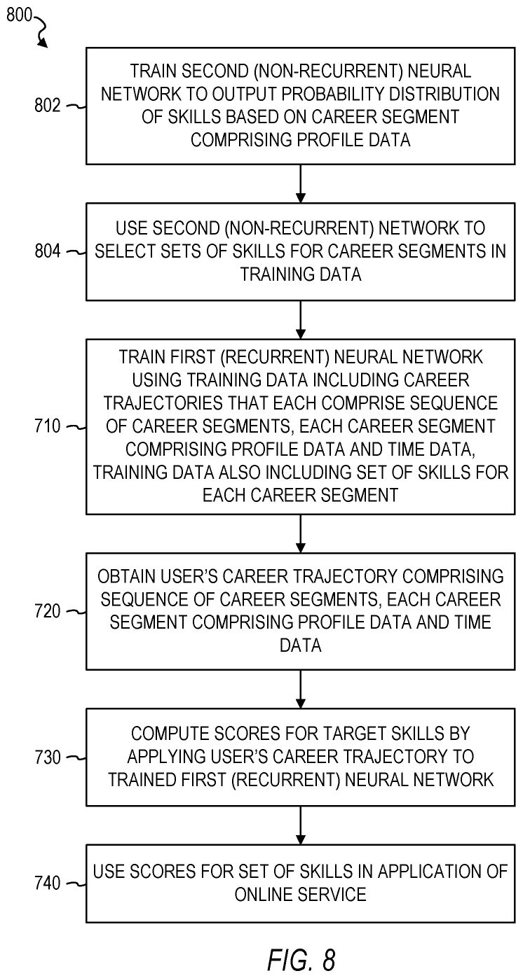

FIG. 8 is a flowchart illustrating another method 800 of training and using a neural network to make predictions using trajectory modelling, in accordance with an example embodiment. The method 800 can be performed by processing logic that can comprise hardware (e.g., circuitry, dedicated logic, programmable logic, microcode, etc.), software (e.g., instructions run on a processing device), or a combination thereof. In one implementation, the method 800 is performed by the online service 100 of FIG. 1, or any combination of one or more of its components (e.g., the neural network component 114, the application component 106), as described above. The method 800 may include operations 802 and 804 being performed prior to operation 710 of the method 700 of FIG. 7.

At operation 802, the online service 100 trains a second neural network 200, using a second machine learning algorithm, to output a probability distribution of skills based on an input career segment comprising input profile data. The term “input” is used herein in association with “career segment” and “profile data” to indicate data being used or involved in the use of the second neural network. The second neural network is different from the first neural network and is not a recurrent neural network. For example, the online service 100 may use the neural network 200 in FIG. 2 as the second neural network and the neural network 300 in FIGS. 3 and 4 as the first neural network.

At operation 804, the online service 100 uses the second neural network to select the corresponding set of reference skills for each reference career segment in the training data. For example, the online service 100 may rank the skills for a career segment based on their respective probabilities in the probability distribution of skills output by the neural network 200, and then select the top K highest ranking skills, where K is a positive integer. The selected skills may then be used along with the career segment as training data for training the first neural network at operation 710.

It is contemplated that any of the other features described within the present disclosure can be incorporated into the method 800.

Certain embodiments are described herein as including logic or a number of components or mechanisms. Components may constitute either software components (e.g., code embodied (1) on a non-transitory machine-readable medium or (2) in a transmission signal) or hardware-implemented components. A hardware-implemented component is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented component that operates to perform certain operations as described herein.

In various embodiments, a hardware-implemented component may be implemented mechanically or electronically. For example, a hardware-implemented component may comprise dedicated circuitry or logic that is permanently configured (e.g., as a special-purpose processor, such as a field programmable gate array (FPGA) or an application-specific integrated circuit (ASIC)) to perform certain operations. A hardware-implemented component may also comprise programmable logic or circuitry (e.g., as encompassed within a programmable processor) that is temporarily configured by software to perform certain operations. It will be appreciated that the decision to implement a hardware-implemented component mechanically, in dedicated and permanently configured circuitry, or in temporarily configured circuitry (e.g., configured by software) may be driven by cost and time considerations.

Accordingly, the term “hardware-implemented component” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented components are temporarily configured (e.g., programmed), each of the hardware-implemented components need not be configured or instantiated at any one instance in time. For example, where the hardware-implemented components comprise a processor configured using software, the processor may be configured as respective different hardware-implemented components at different times. Software may accordingly configure a processor, for example, to constitute a particular hardware-implemented component at one instance of time and to constitute a different hardware-implemented component at a different instance of time.

Hardware-implemented components can provide information to, and receive information from, other hardware-implemented components. Accordingly, the described hardware-implemented components may be regarded as being communicatively coupled. Where multiple of such hardware-implemented components exist contemporaneously, communications may be achieved through signal transmission (e.g., over appropriate circuits and buses) that connect the hardware-implemented components. In embodiments in which multiple hardware-implemented components are configured or instantiated at different times, communications between such hardware-implemented components may be achieved, for example, through the storage and retrieval of information in memory structures to which the multiple hardware-implemented components have access. For example, one hardware-implemented component may perform an operation, and store the output of that operation in a memory device to which it is communicatively coupled. A further hardware-implemented component may then, at a later time, access the memory device to retrieve and process the stored output. Hardware-implemented components may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions. The components referred to herein may, in some example embodiments, comprise processor-implemented components.

Similarly, the methods described herein may be at least partially processor-implemented. For example, at least some of the operations of a method may be performed by one or more processors or processor-implemented components. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs)).

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a component, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

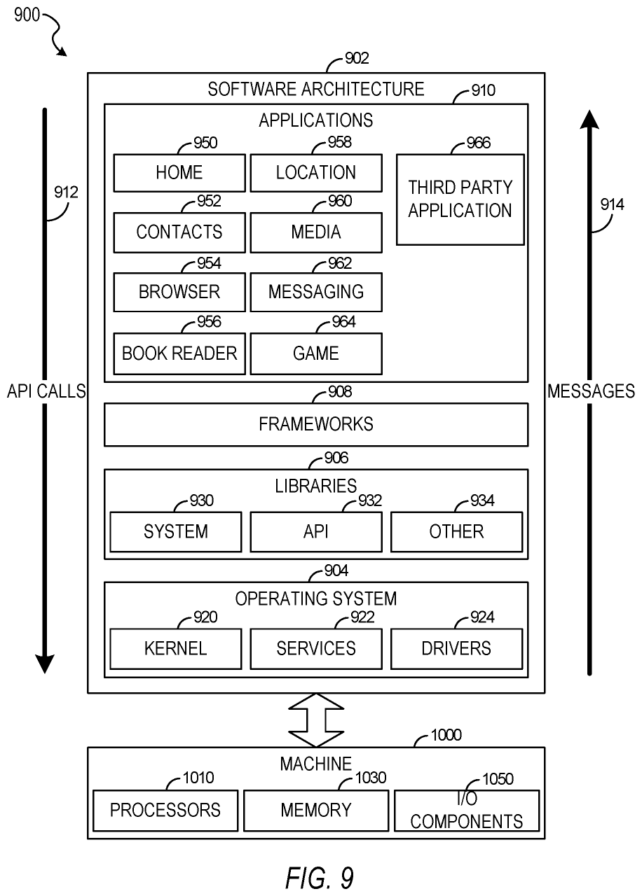

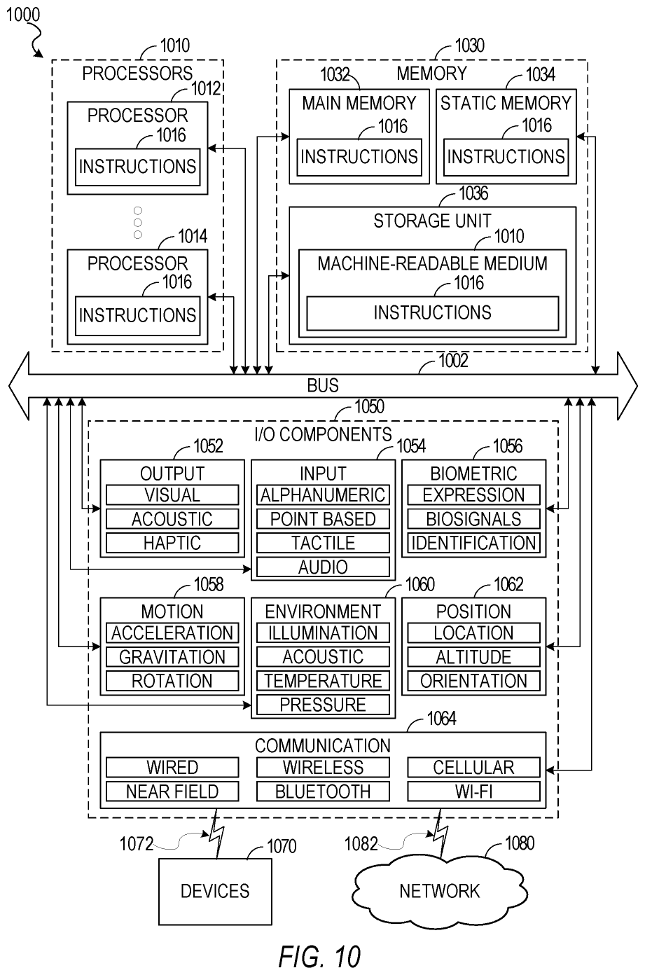

FIG. 9 is a block diagram 900 illustrating a software architecture 902, which can be installed on any one or more of the devices described above. FIG. 9 is merely a non-limiting example of a software architecture, and it will be appreciated that many other architectures can be implemented to facilitate the functionality described herein. In various embodiments, the software architecture 902 is implemented by hardware such as a machine 1000 of FIG. 10 that includes processors 1010, memory 1030, and input/output (I/O) components 1050. In this example architecture, the software architecture 902 can be conceptualized as a stack of layers where each layer may provide a particular functionality. For example, the software architecture 902 includes layers such as an operating system 904, libraries 906, frameworks 908, and applications 910. Operationally, the applications 910 invoke API calls 912 through the software stack and receive messages 914 in response to the API calls 912, consistent with some embodiments.

In various implementations, the operating system 904 manages hardware resources and provides common services. The operating system 904 includes, for example, a kernel 920, services 922, and drivers 924. The kernel 920 acts as an abstraction layer between the hardware and the other software layers, consistent with some embodiments. For example, the kernel 920 provides memory management, processor management (e.g., scheduling), component management, networking, and security settings, among other functionality. The services 922 can provide other common services for the other software layers. The drivers 924 are responsible for controlling or interfacing with the underlying hardware, according to some embodiments. For instance, the drivers 924 can include display drivers, camera drivers, BLUETOOTH® or BLUETOOTH® Low Energy drivers, flash memory drivers, serial communication drivers (e.g., Universal Serial Bus (USB) drivers), Wi-Fi® drivers, audio drivers, power management drivers, and so forth.

In some embodiments, the libraries 906 provide a low-level common infrastructure utilized by the applications 910. The libraries 906 can include system libraries 930 (e.g., C standard library) that can provide functions such as memory allocation functions, string manipulation functions, mathematic functions, and the like. In addition, the libraries 906 can include API libraries 932 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic context on a display), database libraries (e.g., SQLite to provide various relational database functions), web libraries (e.g., WebKit to provide web browsing functionality), and the like. The libraries 906 can also include a wide variety of other libraries 934 to provide many other APIs to the applications 910.

The frameworks 908 provide a high-level common infrastructure that can be utilized by the applications 910, according to some embodiments. For example, the frameworks 908 provide various GUI functions, high-level resource management, high-level location services, and so forth. The frameworks 908 can provide a broad spectrum of other APIs that can be utilized by the applications 910, some of which may be specific to a particular operating system 904 or platform.

In an example embodiment, the applications 910 include a home application 950, a contacts application 952, a browser application 954, a book reader application 956, a location application 958, a media application 960, a messaging application 962, a game application 964, and a broad assortment of other applications, such as a third-party application 966. According to some embodiments, the applications 910 are programs that execute functions defined in the programs. Various programming languages can be employed to create one or more of the applications 910, structured in a variety of manners, such as object-oriented programming languages (e.g., Objective-C, Java, or C++) or procedural programming languages (e.g., C or assembly language). In a specific example, the third-party application 966 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 966 can invoke the API calls 912 provided by the operating system 904 to facilitate functionality described herein.

FIG. 10 illustrates a diagrammatic representation of a machine 1000 in the form of a computer system within which a set of instructions may be executed for causing the machine 1000 to perform any one or more of the methodologies discussed herein, according to an example embodiment. Specifically, FIG. 10 shows a diagrammatic representation of the machine 1000 in the example form of a computer system, within which instructions 1016 (e.g., software, a program, an application 910, an applet, an app, or other executable code) for causing the machine 1000 to perform any one or more of the methodologies discussed herein may be executed. For example, the instructions 1016 may cause the machine 1000 to execute the method 700 of FIG. 7. Additionally, or alternatively, the instructions 1016 may implement FIGS. 1-7, and so forth. The instructions 1016 transform the general, non-programmed machine 1000 into a particular machine 1000 programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a PC, a tablet computer, a laptop computer, a netbook, a set-top box (STB), a portable digital assistant (PDA), an entertainment media system, a cellular telephone, a smartphone, a mobile device, a wearable device (e.g., a smart watch), a smart home device (e.g., a smart appliance), other smart devices, a web appliance, a network router, a network switch, a network bridge, or any machine capable of executing the instructions 1016, sequentially or otherwise, that specify actions to be taken by the machine 1000. Further, while only a single machine 1000 is illustrated, the term “machine” shall also be taken to include a collection of machines 1000 that individually or jointly execute the instructions 1016 to perform any one or more of the methodologies discussed herein.

The machine 1000 may include processors 1010, memory 1030, and I/O components 1050, which may be configured to communicate with each other such as via a bus 1002. In an example embodiment, the processors 1010 (e.g., a central processing unit (CPU), a reduced instruction set computing (RISC) processor, a complex instruction set computing (CISC) processor, a graphics processing unit (GPU), a digital signal processor (DSP), an application-specific integrated circuit (ASIC), a radio-frequency integrated circuit (RFIC), another processor, or any suitable combination thereof) may include, for example, a processor 1012 and a processor 1014 that may execute the instructions 1016. The term “processor” is intended to include multi-core processors 1010 that may comprise two or more independent processors 1012 (sometimes referred to as “cores”) that may execute instructions 1016 contemporaneously. Although FIG. 10 shows multiple processors 1010, the machine 1000 may include a single processor 1012 with a single core, a single processor 1012 with multiple cores (e.g., a multi-core processor), multiple processors 1010 with a single core, multiple processors 1010 with multiple cores, or any combination thereof.

The memory 1030 may include a main memory 1032, a static memory 1034, and a storage unit 1036, all accessible to the processors 1010 such as via the bus 1002. The main memory 1032, the static memory 1034, and the storage unit 1036 store the instructions 1016 embodying any one or more of the methodologies or functions described herein. The instructions 1016 may also reside, completely or partially, within the main memory 1032, within the static memory 1034, within the storage unit 1036, within at least one of the processors 1010 (e.g., within the processor's cache memory), or any suitable combination thereof, during execution thereof by the machine 1000.

The I/O components 1050 may include a wide variety of components to receive input, provide output, produce output, transmit information, exchange information, capture measurements, and so on. The specific I/O components 1050 that are included in a particular machine 1000 will depend on the type of machine 1000. For example, portable machines such as mobile phones will likely include a touch input device or other such input mechanisms, while a headless server machine will likely not include such a touch input device. It will be appreciated that the I/O components 1050 may include many other components that are not shown in FIG. 10. The I/O components 1050 are grouped according to functionality merely for simplifying the following discussion, and the grouping is in no way limiting. In various example embodiments, the I/O components 1050 may include output components 1052 and input components 1054. The output components 1052 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The input components 1054 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and/or force of touches or touch gestures, or other tactile input components), audio input components (e.g., a microphone), and the like.

In further example embodiments, the I/O components 1050 may include biometric components 1056, motion components 1058, environmental components 1060, or position components 1062, among a wide array of other components. For example, the biometric components 1056 may include components to detect expressions (e.g., hand expressions, facial expressions, vocal expressions, body gestures, or eye tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 1058 may include acceleration sensor components (e.g., accelerometer), gravitation sensor components, rotation sensor components (e.g., gyroscope), and so forth. The environmental components 1060 may include, for example, illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detect concentrations of hazardous gases for safety or to measure pollutants in the atmosphere), or other components that may provide indications, measurements, or signals corresponding to a surrounding physical environment. The position components 1062 may include location sensor components (e.g., a Global Positioning System (GPS) receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1050 may include communication components 1064 operable to couple the machine 1000 to a network 1080 or devices 1070 via a coupling 1082 and a coupling 1072, respectively. For example, the communication components 1064 may include a network interface component or another suitable device to interface with the network 1080. In further examples, the communication components 1064 may include wired communication components, wireless communication components, cellular communication components, near field communication (NFC) components, Bluetooth® components (e.g., Bluetooth® Low Energy), Wi-Fi® components, and other communication components to provide communication via other modalities. The devices 1070 may be another machine or any of a wide variety of peripheral devices (e.g., a peripheral device coupled via a USB).

Moreover, the communication components 1064 may detect identifiers or include components operable to detect identifiers. For example, the communication components 1064 may include radio frequency identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 1064, such as location via Internet Protocol (IP) geolocation, location via Wi-Fi® signal triangulation, location via detecting an NFC beacon signal that may indicate a particular location, and so forth.

The various memories (i.e., 1030, 1032, 1034, and/or memory of the processor(s) 1010) and/or the storage unit 1036 may store one or more sets of instructions 1016 and data structures (e.g., software) embodying or utilized by any one or more of the methodologies or functions described herein. These instructions (e.g., the instructions 1016), when executed by the processor(s) 1010, cause various operations to implement the disclosed embodiments.

As used herein, the terms “machine-storage medium,” “device-storage medium,” and “computer-storage medium” mean the same thing and may be used interchangeably. The terms refer to a single or multiple storage devices and/or media (e.g., a centralized or distributed database, and/or associated caches and servers) that store executable instructions 1016 and/or data. The terms shall accordingly be taken to include, but not be limited to, solid-state memories, and optical and magnetic media, including memory internal or external to the processors 1010. Specific examples of machine-storage media, computer-storage media, and/or device-storage media include non-volatile memory including, by way of example, semiconductor memory devices, e.g., erasable programmable read-only memory (EPROM), electrically erasable programmable read-only memory (EEPROM), field-programmable gate array (FPGA), and flash memory devices; magnetic disks such as internal hard disks and removable disks; magneto-optical disks; and CD-ROM and DVD-ROM disks. The terms “machine-storage media,” “computer-storage media,” and “device-storage media” specifically exclude carrier waves, modulated data signals, and other such media, at least some of which are covered under the term “signal medium” discussed below.

In various example embodiments, one or more portions of the network 1080 may be an ad hoc network, an intranet, an extranet, a virtual private network (VPN), a local area network (LAN), a wireless LAN (WLAN), a WAN, a wireless WAN (WWAN), a metropolitan area network (MAN), the Internet, a portion of the Internet, a portion of the public switched telephone network (PSTN), a plain old telephone service (POTS) network, a cellular telephone network, a wireless network, a Wi-Fi® network, another type of network, or a combination of two or more such networks. For example, the network 1080 or a portion of the network 1080 may include a wireless or cellular network, and the coupling 1082 may be a Code Division Multiple Access (CDMA) connection, a Global System for Mobile communications (GSM) connection, or another type of cellular or wireless coupling. In this example, the coupling 1082 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High-Speed Packet Access (HSPA), Worldwide Interoperability for Microwave Access (WiMAX), Long-Term Evolution (LTE) standard, others defined by various standard-setting organizations, other long-range protocols, or other data-transfer technology.

The instructions 1016 may be transmitted or received over the network 1080 using a transmission medium via a network interface device (e.g., a network interface component included in the communication components 1064) and utilizing any one of a number of well-known transfer protocols (e.g., HTTP). Similarly, the instructions 1016 may be transmitted or received using a transmission medium via the coupling 1072 (e.g., a peer-to-peer coupling) to the devices 1070. The terms “transmission medium” and “signal medium” mean the same thing and may be used interchangeably in this disclosure. The terms “transmission medium” and “signal medium” shall be taken to include any intangible medium that is capable of storing, encoding, or carrying the instructions 1016 for execution by the machine 1000, and include digital or analog communications signals or other intangible media to facilitate communication of such software. Hence, the terms “transmission medium” and “signal medium” shall be taken to include any form of modulated data signal, carrier wave, and so forth. The term “modulated data signal” means a signal that has one or more of its characteristics set or changed in such a manner as to encode information in the signal.

The terms “machine-readable medium,” “computer-readable medium,” and “device-readable medium” mean the same thing and may be used interchangeably in this disclosure. The terms are defined to include both machine-storage media and transmission media. Thus, the terms include both storage devices/media and carrier waves/modulated data signals.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method performed by a computer system having a memory and at least one hardware processor, the computer-implemented method comprising:
training a first neural network with a first machine learning algorithm using training data, the first neural network being a recurrent neural network, the training data including a plurality of reference career trajectories, each reference career trajectory in the plurality of reference career trajectories comprising a sequence of reference career segments, each reference career segment in the sequence of reference career segments comprising reference profile data and reference time data indicating a position of the reference career segment within the sequence of reference career segments, the training data also including a corresponding set of reference skills for each reference career segment;
obtaining a target career trajectory of a target user of an online service, the target career trajectory comprising a sequence of target career segments, each target career segment in the sequence of target career segments comprising target profile data of the target user and target time data indicating a position of the target career segment within the sequence of target career segments;
for each target skill in a set of target skills, computing a corresponding score for the respective target skill by applying the target career trajectory to the trained first neural network; and
using the corresponding scores for the set of target skills in an application of the online service.

2. The computer-implemented method of claim 1, further comprising:
training a second neural network, with a second machine learning algorithm, to output a probability distribution of skills based on an input career segment comprising input profile data, the second neural network being different from the first neural network and not being a recurrent neural network; and
using the second neural network to select the corresponding set of reference skills for each reference career segment in the training data.

3. The computer-implemented method of claim 1, wherein the first neural network comprises an encoder-decoder architecture, the encoder-decoder architecture comprising an encoder network and a decoder network.

4. The computer-implemented method of claim 3, wherein the encoder network comprises a first plurality of gated recurrent units and the decoder network comprises a second plurality of gated recurrent units.

5. The computer-implemented method of claim 3, wherein the encoder network comprises a first plurality of long short-term memory units and the decoder network comprises a second plurality of long short-term memory units.

6. The computer-implemented method of claim 1, wherein the reference profile data comprises one or more profile data comprising: a job title, a seniority level, a company, an industry, or a description of the corresponding reference career segment.

7. The computer-implemented method of claim 1, wherein the target profile data comprises one or more profile data comprising: a job title, a seniority level, a company, an industry, or a description of the corresponding target career segment.

8. The computer-implemented method of claim 1, wherein the using the corresponding scores for the set of target skills in the application of the online service comprises:
selecting one or more target skills from the set of target skills based on the corresponding scores of the one or more target skills; and
displaying a corresponding selectable user interface element for each one of the selected one or more target skills on a computing device of the target user, the corresponding selectable user interface element being configured to trigger storing of the corresponding target skill as part of a profile of the target user in response to a selection of the corresponding selectable user interface element, the profile being stored on the online service.

9. The computer-implemented method of claim 1, wherein the using the corresponding scores for the set of skills in the application of the online service comprises:
receiving a search query submitted by the target user via a computing device of the target user;
computing a corresponding score for each job posting in a plurality of job postings based on the search query and the corresponding scores for the set of skills;
selecting one or more job postings from the plurality of job postings based on the corresponding scores for the one or more job postings; and
displaying the selected one or more job postings as search results for the search query on the computing device of the target user.

10. The computer-implemented method of claim 1, wherein the using the corresponding scores for the set of skills in the application of the online service comprises:
computing a corresponding score for each job posting in a plurality of job postings based on the corresponding scores for the set of skills;
selecting one or more job postings from the plurality of job postings based on the corresponding scores for the one or more job postings; and
displaying the selected one or more job postings on a computing device of the target user.

11. The computer-implemented method of claim 1, wherein the using the corresponding scores for the set of skills in the application of the online service comprises:
computing a corresponding score for each online course in a plurality of online courses based on the corresponding scores for the set of skills;
selecting one or more online courses from the plurality of online courses based on the corresponding scores for the one or more online courses; and
displaying the selected one or more online courses on a computing device of the target user.

12. A system comprising:
a neural network component configured to train a first neural network with a first machine learning algorithm using training data, the first neural network being a recurrent neural network, the training data including a plurality of reference career trajectories, each reference career trajectory in the plurality of reference career trajectories comprising a sequence of reference career segments, each reference career segment in the sequence of reference career segments comprising reference profile data and reference time data indicating a position of the reference career segment within the sequence of reference career segments, the training data also including a corresponding set of reference skills for each reference career segment; and
an application component configured to:
obtain a target career trajectory of a target user of an online service, the target career trajectory comprising a sequence of target career segments, each target career segment in the sequence of target career segments comprising target profile data of the target user and target time data indicating a position of the target career segment within the sequence of target career segments;
for each target skill in a set of target skills, compute a corresponding score for the respective target skill by applying the target career trajectory to the trained first neural network; and
use the corresponding scores for the set of target skills in an application of the online service.

13. The system of claim 12, wherein the neural network component is further configured to:
train a second neural network, with a second machine learning algorithm, to output a probability distribution of skills based on an input career segment comprising input profile data, the second neural network being different from the first neural network and not being a recurrent neural network; and
use the second neural network to select the corresponding set of reference skills for each reference career segment in the training data.

14. The system of claim 12, wherein the first neural network comprises an encoder-decoder architecture, the encoder-decoder architecture comprising an encoder network and a decoder network.

15. The system of claim 14, wherein the encoder network comprises a first plurality of gated recurrent units and the decoder network comprises a second plurality of gated recurrent units.

16. The system of claim 14, wherein the encoder network comprises a first plurality of long short-term memory units and the decoder network comprises a second plurality of long short-term memory units.

17. The system of claim 12, wherein the application component is configured to the use the corresponding scores for the set of target skills in the application of the online service by:
selecting one or more target skills from the set of target skills based on the corresponding scores of the one or more target skills; and
displaying a corresponding selectable user interface element for each one of the selected one or more target skills on a computing device of the target user, the corresponding selectable user interface element being configured to trigger storing of the corresponding target skill as part of a profile of the target user in response to a selection of the corresponding selectable user interface element, the profile being stored on the online service.

18. The system of claim 12, wherein the application component is configured to use the corresponding scores for the set of skills in the application of the online service by:
receiving a search query submitted by the target user via a computing device of the target user;
computing a corresponding score for each job posting in a plurality of job postings based on the search query and the corresponding scores for the set of skills;
selecting one or more job postings from the plurality of job postings based on the corresponding scores for the one or more job postings; and
displaying the selected one or more job postings as search results for the search query on the computing device of the target user.

19. The system of claim 12, wherein the application component is configured to use the corresponding scores for the set of skills in the application of the online service by:
computing a corresponding score for each job posting in a plurality of job postings based on the corresponding scores for the set of skills;
selecting one or more job postings from the plurality of job postings based on the corresponding scores for the one or more job postings; and
displaying the selected one or more job postings on a computing device of the target user.

20. A non-transitory machine-readable medium embodying a set of instructions that, when executed by at least one hardware processor, cause the processor to perform operations, the operations comprising:
training a first neural network with a first machine learning algorithm using training data, the first neural network being a recurrent neural network, the training data including a plurality of reference career trajectories, each reference career trajectory in the plurality of reference career trajectories comprising a sequence of reference career segments, each reference career segment in the sequence of reference career segments comprising reference profile data and reference time data indicating a position of the reference career segment within the sequence of reference career segments, the training data also including a corresponding set of reference skills for each reference career segment;
obtaining a target career trajectory of a target user of an online service, the target career trajectory comprising a sequence of target career segments, each target career segment in the sequence of target career segments comprising target profile data of the target user and target time data indicating a position of the target career segment within the sequence of target career segments;
for each target skill in a set of target skills, computing a corresponding score for the respective target skill by applying the target career trajectory to the trained first neural network; and
using the corresponding scores for the set of target skills in an application of the online service.
